(19) United States
(12) Patent Application Publication
(10) Pub. No.: US 2017/0185609 A1
(43) Pub. Date: Jun. 29, 2017

(54) UNIVERSAL ADAPTOR FOR RAPID DEVELOPMENT OF WEB-BASED DATA VISUALIZATIONS

(71) Applicant: INTERNATIONAL BUSINESS MACHINES CORPORATION, Armonk, NY (US)

(72) Inventors: Stefano BRAGHIN, Dublin (IE); Ioannis GKOUFAS, East Wall (IE); Nuno LOPES, Dublin (IE); Rudi VERAGO, Dublin (IE)

(21) Appl. No.: 14/980,043

(22) Filed: Dec. 28, 2015

(51) Int. Cl. G06F 17/30; H04L 29/08

(52) U.S. Cl. CPC G06F 17/3089; G06F 17/30377; H04L 67/02

(57) ABSTRACT

A method of web-based data visualization includes: a Frontend sending a request over a computer network to a server configured as a Backend; a web server of the second server fetching data responsive to the request; the web server sending a response to the Frontend in a format compatible with a plurality software adaptors located on the Frontend, the response including information about objects to be presented on a web component; logic of the Frontend passing the response to a selected one of the software adaptors; and the selected software adaptor rendering the using a web visualization library associated with selected software adaptor.

### BACKGROUND

The present invention relates generally to web-based data visualizations, and more particularly to mechanisms to change these web-based data visualizations by modifying the frontend and the backend.

In software engineering, the terms “frontend” and “backend” are distinctions, which refer to the separation of concerns between a presentation layer and a data access layer, respectively. A variety of web frameworks are focused on either the backend, or the web client. There are no standard conventions for component communication or widget communication, above all for data visualization. There are a few tools that offer a unified approach on building both frontend and backends. Unfortunately, those approaches do not offer interoperability with other backend or frontend systems. To change a server or a user interface, it is required to realize a new implementation with a new visualization library and update the server side accordingly by recompiling the entire architecture.

### SUMMARY

According to an exemplary embodiment of the invention, a method of web-based data visualization includes: sending, by a client configured as a Frontend, a request over a computer network to a server configured as a Backend; fetching, by a web server of the server, data responsive to the request; sending, by the web server, a response to the Frontend in a format compatible with a plurality software adaptors located on the Frontend, the response including information about objects to be presented on a web component; passing, by logic of the Frontend, the response to a selected one of the software adaptors; and rendering, by the selected software adaptor, the web component (widget) using a web visualization library associated with selected software adaptor.

According to an exemplary embodiment of the invention, a method of web-based data visualization includes: sending, by a client configured as a Frontend, a request for data of a webpage over a computer network to a server configured as a Backend; passing, by logic of the Frontend, a first message received in response to the request to a selected one of a plurality software adaptors, wherein the first message is a format compatible with the software adaptors, and the first message includes information about objects to be presented on the web component; and rendering, by the selected software adaptor, the web component using a web visualization library associated with selected software adaptor.

According to an exemplary embodiment of the invention, a method of web-based data visualization includes: mapping, by logic of a server configured as a Backend, a request to a method of a web server of the Backend; fetching, by the web server, data responsive to the request in response to the mapping; and sending, by the web server, a response to a client configured as a Frontend that sent the request in a format compatible with a plurality software adaptors located on the Frontend, the response including information about objects to be presented on the web component. The format that is compatible with the plurality of software adaptors is not compatible with web visualization libraries associated with the software adaptors.

### BRIEF DESCRIPTION OF THE SEVERAL VIEWS OF THE DRAWINGS

Through the more detailed description of some embodiments of the present disclosure in the accompanying drawings, features of the present disclosure will become more apparent, wherein:

FIG. 1 illustrates a cloud computing environment according to an embodiment of the present invention;

FIG. 2 depicts abstraction model layers according to an embodiment of the present invention, which may be used to implement a network application such as backend or a frontend;

FIG. 3 shows an exemplary computer system, in which the network application may reside;

FIG. 4 illustrates a system according to an exemplary embodiment of the invention;

FIG. 5 illustrates a workflow of the system according to an exemplary embodiment of the invention;

FIG. 6 illustrates an example of the format of a data message sent from a controller of a backend according to an embodiment of the invention to a frontend according to an embodiment of the invention;

FIG. 7 illustrates a method of the workflow according to an exemplary embodiment of the invention;

FIG. 8 illustrates a method of the workflow according to an exemplary embodiment of the invention;

FIG. 9 illustrates a method of the workflow according to an exemplary embodiment of the invention;

FIG. 10 illustrates a method of the workflow according to an exemplary embodiment of the invention; and

FIG. 11 illustrates a method of the workflow according to an exemplary embodiment of the invention.

### DETAILED DESCRIPTION

The inventive concept will be described in more detail with reference to the accompanying drawings, where exemplary embodiments of the present disclosure have been illustrated. Throughout the drawings, same or like reference numerals are used to represent the same or like components. However, the present inventive concept can be implemented in various manners, and thus should not be construed to be limited to the embodiments disclosed herein. On the contrary, those embodiments are provided for the thorough and complete understanding of the present disclosure to convey the scope of the present disclosure to those skilled in the art.

An embodiment of the invention introduces an adaptor layer (e.g., a visualization adaptor) for the data visualization, introduces specifications for the data exchange between frontend and backend, and introduces a workflow for the interaction between frontend and backend. This allows for an easy switch between visualization libraries, provides decoupling of the backend and the frontend, and provides a speedup of the development of web-based data visualization. It is also possible to render multiple visualizations using the same backend (i.e., a one to many mapping).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

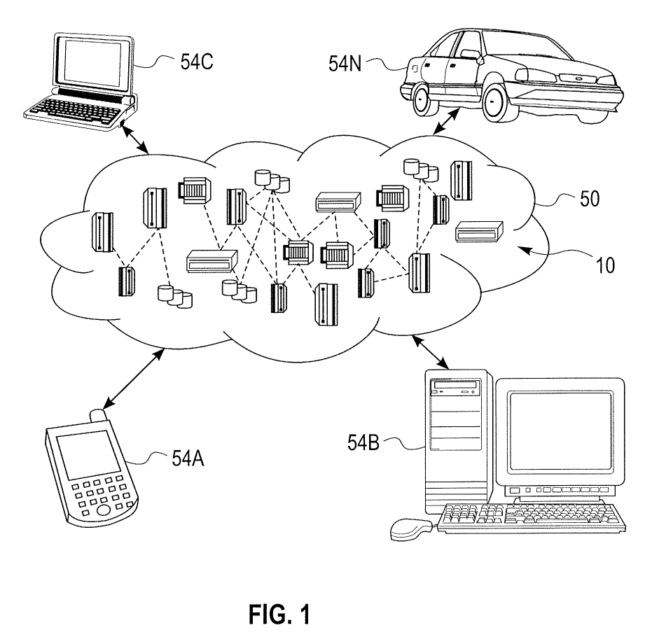

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure comprising a network of interconnected nodes. Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

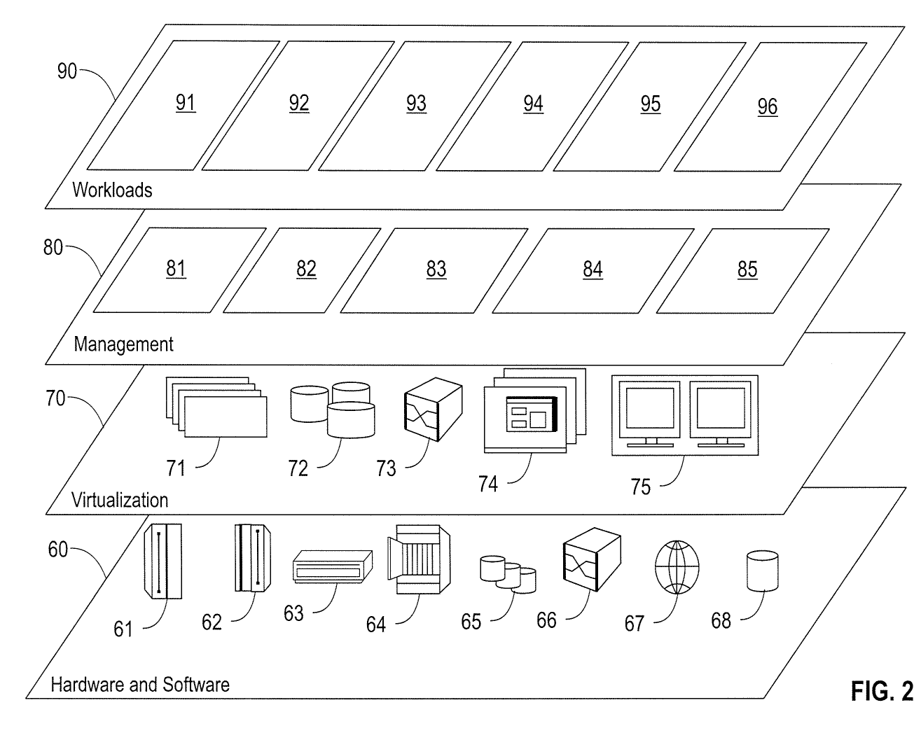

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a network application 96 such as a backend.

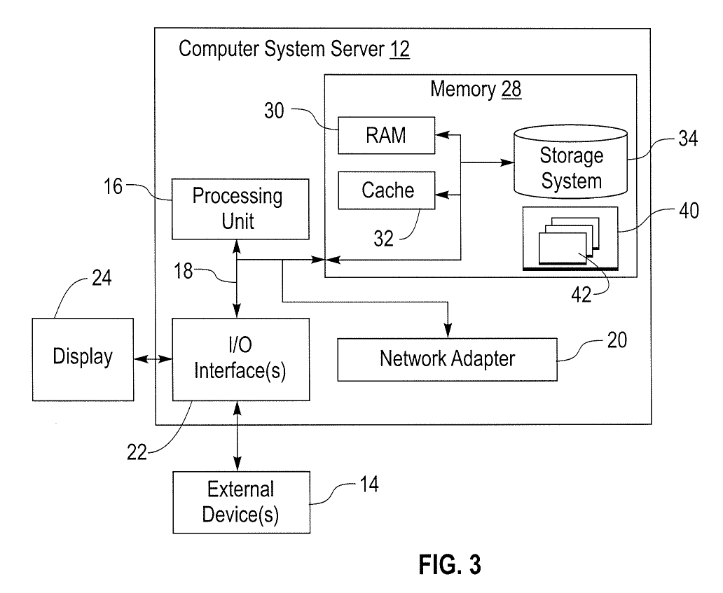

FIG. 3 illustrates an embodiment of a computer server that may be used to implement part of computing devices 54A-54N, and the network application 96 that is applicable to implementing embodiments of the present invention. Computer system/server 12 is only illustrative and is not intended to suggest any limitation as to the scope of use or functionality of embodiments of the invention described herein.

As shown in FIG. 3, the computer system/server 12 is shown in the form of a general-purpose computing device. The components of the computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus.

The computer system/server 12 may include a variety of computer system readable media. Such media may be any available media that is accessible by the computer system/server 12, and it includes both volatile and non-volatile media, removable and non-removable media.

The system memory 28 can include computer system readable media in the form of volatile memory, such as random access memory (RAM) 30 and/or cache memory 32. The computer system/server 12 may further include other removable/non-removable, volatile/non-volatile computer system storage media. By way of example, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

A program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein.

The computer system/server 12 may also communicate with one or more external devices 14 such as a keyboard, a pointing device, a display 24, etc.; one or more devices that enable a user to interact with the computer system/server 12; and/or any devices (e.g., network card, modem, etc.) that enable the computer system/server 12 to communicate with one or more other computing devices. Such communication can occur via Input/Output (I/O) interfaces 22. The computer system/server 12 can communicate with one or more networks such as a local area network (LAN), a general wide area network (WAN), and/or a public network (e.g., the Internet) via a network adapter 20. As depicted, the network adapter 20 communicates with the other components of computer system/server 12 via the bus 18. It should be understood that although not shown, other hardware and/or software components could be used in conjunction with the computer system/server 12. Examples of these other hardware and/or software components include, but are not limited to: microcode, device drivers, redundant processing units, external disk drive arrays, RAID systems, tape drives, and data archival storage systems.

Embodiments of the invention introduce a set of specifications for data/route communication, where a backend and a frontend are developed following these specifications. For example, when JavaScript libraries are used, these libraries need to implement this set of conventions by using a software layer (e.g., wrapper/adaptor). The conventions provide an abstraction of the model and controller layers so it is possible to plug and play many different JavaScript libraries during any phase (e.g., development, production, test, etc.). The tradeoff is the development of the wrapper/adaptor, which might be done by the frontend engineer or by the library developer. While use of different JavaScript libraries is primarily discussed, the inventive is not limited to JavaScript libraries and may be applied to other libraries used to visualize graphics on a webpage such as ADOBE flash, HTML5, and COFFEESCRIPT.

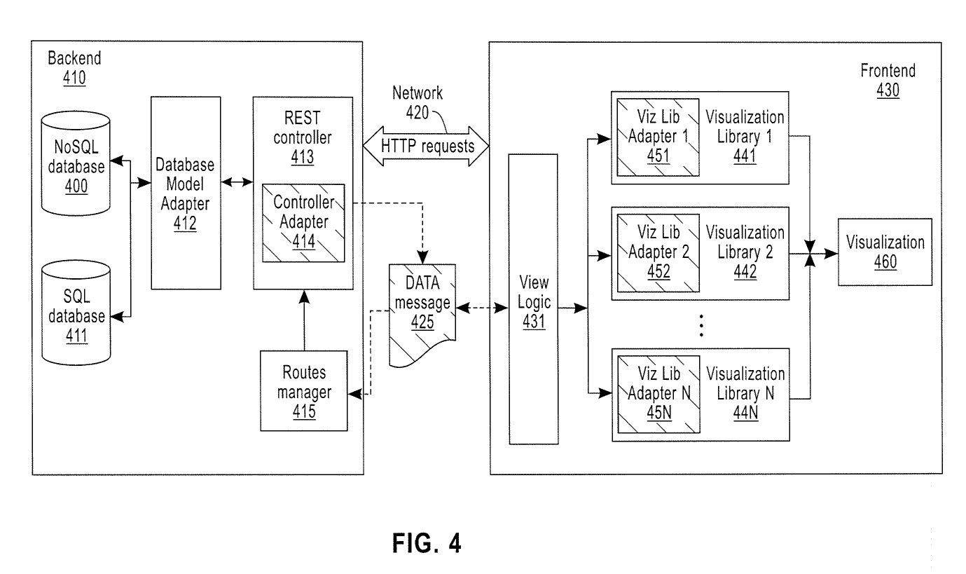

FIG. 4 a system according to an exemplary embodiment of the invention. The system includes a Backend 410 and a Frontend 430 configured to communicate with one another across a computer network 420. The Backend 410 may be the network application 96 illustrated in FIG. 2, the Backend 410 may be an application running on computer server 12 of FIG. 3, or the Frontend 430 may be an application running on computer server 12, as an example. The Frontend 430 may be part of a browser application (e.g., referred to as a browser) or be separate from the browser.

The Backend 410 includes a NoSQL database 400, an SQL database 411, a Database Model adaptor 412, a REST Controller 413 (e.g., a Representational State Transfer capable web server), and a Routes Manager 415. The REST controller 413 additionally includes a Controller Adaptor 414. The REST controller 413 may be implemented by a RESTful application that uses HTTP requests to post data, read data, and delete data. Examples of the NoSQL 400 database include but are not limited to MongoDB, MarkLogic, Datastax, etc. Examples of the SQL database 411 include but are not limited to MySQL, ORACLE, DB2, etc.

The Frontend 430 includes View Logic 431 and a plurality of different Visualization Libraries 441, 442, . . . , 44N. Each Visualization Library includes a corresponding one of a plurality of Visualization Library Adaptors 451, 452, . . . , 45N. Examples of the Visualization libraries include D3.js, Rave, and HTML5/JS.

The Database Model Adaptor 412 is shown interfacing with the NoSQL database 400 and the SQL database 411 merely as an example. The Database Model Adaptor 412 is not limited to interfacing with the two illustrated databases, as additional databases of various types can be added. Further, the Database Model Adaptor 412 is configured to interface with other components (not illustrated) that are able to store data and make data available to requesting parties such as one or more file systems.

The Database Model Adaptor 412 is configured to process a database request from the REST controller 413. The database request may include a request to update data of a database (e.g., 410, 411, etc.), delete data of a database, read data from a database, or insert new data into a database. The database request may include information that can be used by the Database Model Adaptor 412 to determine which one of the databases is the subject or location of the database request. The Database Model Adaptor 412 can convert the database request into a format that can be understood by the database that is the subject of the database request. For example, the Database Model Adaptor 412 can convert the database request into a query of an SQL format when the SQL database 411 is the subject of the database request/query of a non-SQL format when the NoSQL database 400 is the subject of the database request/query.

The Backend 410 and the Frontend 430 are configured to communicate with one another over the Network 420 using a Hypertext Transfer Protocol (HTTP). The Backend 410 can process HTTP requests from the Frontend 430 and the Frontend 430 can process HTTP requests from the Backend 410. An HTTP request includes a Request-Line, which includes a method token (e.g., a request method), a Request-Uniform Resource Identifier (Request-URI) and a protocol version (e.g., HTTP/1.1). The request method indicates the method to be performed on the resource identified by the given Request-URI. Examples of the request method include but are not limited to GET (e.g., used to retrieve information from a given server or database using a given URI), POST (e.g., use to send data to a given server or database), and DELETE (e.g., removes all the current representations of a target resource given by the URI). The Request-URI identifies the resource upon which to apply the request. For example, the Request-URI could identify that a desired web page or web component (e.g., part of web page) is located on the SQL database 411.

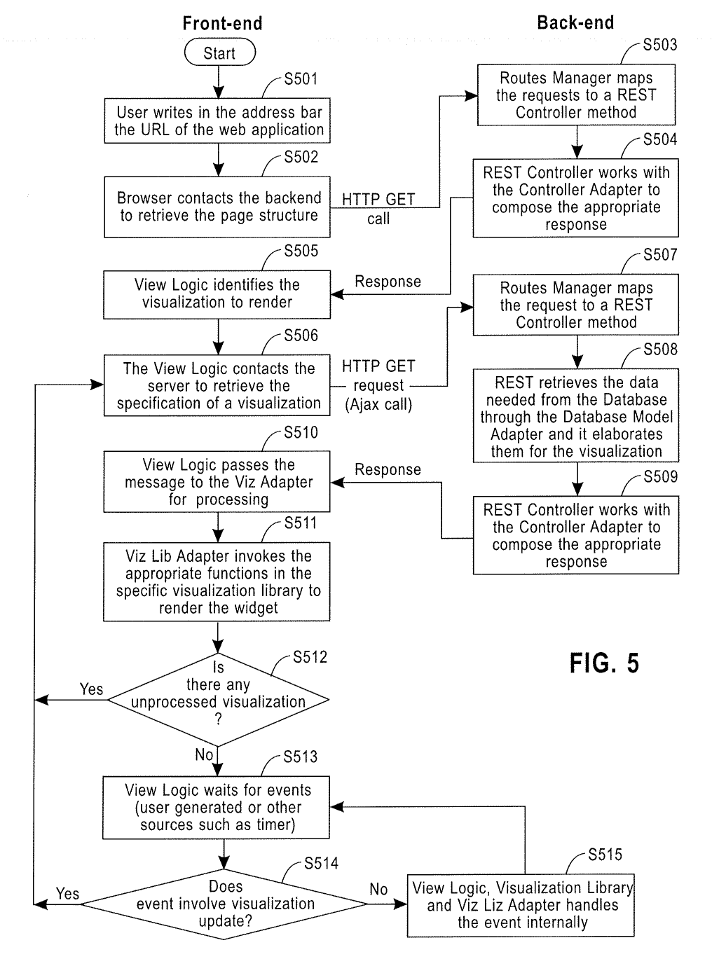

FIG. 5 illustrates of a workflow of the system of FIG. 4 according to an exemplary embodiment of the invention. Initially in the workflow, a user writes in the address bar of a browser, the URL of a web application (S501). The URL may also be selected by the user selecting a link illustrated by the browser. The browser may be part of the Frontend 430 or be configured to communicate with the Frontend 430. Examples of the browser include INTERNET EXPLORER, SAFARI, and CHROME.

The browser contacts the Backend 410 to retrieve a page structure of a webpage referenced by the URL (S502). For example, the page structure may indicate how the webpage is organized by identifying the graphical elements (e.g., images, graphs, charts, tables, etc.) that are to appear on the webpage and the positions and extents of those elements. As an example, the browser may perform this contact using an HTTP GET call, which is enclosed within the illustrated data message 425, and includes one or more requests.

The Routes Manager 415 of the Backend 410 in response to receipt of the call, maps the requests to a REST method of the REST controller 413 (S503). This mapping may involve the Routes Manager 415 sending a message to the REST controller 413 informing it of the particular REST method to invoke.

The REST controller 413 works with its Controller Adaptor 414 to compose an appropriate response describing the page structure, and sends the response to the Frontend 430 (S504).

The View Logic 431 of the Frontend 430 receives the response describing the page structure and identifies a particular visualization to render from among the page structure (S505).

The View Logic 431 contacts the Backend 410 to retrieve a specification (e.g., data representing the identified visualization) of the identified visualization (S506). The View Logic 431 may perform this contact by sending an HTTP GET request message or an AJAX call to the Backend 410. AJAX stands for Asynchronous JavaScript and XML, which can use an XMLHttpRequest object to communicate with server-side scripts to send and receive information in a variety of formats including JSON, XML, HTML, and text files.

In response to receipt of the request, the Routes Manager 415 of the Backend 410 maps the request to REST method of the REST controller 413 (S507). This mapping may include the Routes Manager 415 sending a message to the REST controller 413 to inform of the particular REST method to invoke.

The REST controller 413 retrieves the data needed to respond to the request from a database through the Database Model Adaptor (S508).

The REST controller 413 works with its Controller Adaptor 414 to format the retrieved data into a message (e.g., DATA message 425) in format defined by an embodiment of the invention that is understandable by one or more of the Visualization Library Adaptors 451-45N and sends the message to the Frontend 430 (S509).

The View Logic 431 passes the message to a selected one of the Visualization Library Adaptors 451-45N for processing (S510). In an embodiment, the formatted message is in a proprietary format that is not understandable by the Visualization Libraries 441-44N without use of their respective Visualization Adaptors 451-45N. Each Visualization Library Adaptor 441-44N is configured to convert the message of the proprietary format into a data of compatible format that is understandable by its respective Visualization Library, and each of the Visualization Libraries 441-44N differ from one another.

The Selected Visualization Library Adaptor (e.g., 451), based on the data of compatible format, invokes appropriate functions in its corresponding Visualization Library (e.g., 441) to render a widget (S511). For example, if the first Visualization Library 441 is a D3.js JavaScript library (e.g. a Data-Driven Documents JavaScript library) and the first Visualization Library Adaptor 451 is the selected Adaptor, the first Visualization Library Adaptor 451 converts the message 425 of the proprietary format to calls or code that is compatible with the D3.Js JavaScript library so they can be invoked in the D3.js JavaScript library to render the widget. For example, if the second Visualization Library 442 is a RAVE JavaScript library and the second Visualization Library Adaptor 452 is the selected Adaptor, the second Visualization Library Adaptor 452 converts the message 425 of the proprietary format to calls or code that is compatible with the RAVE JavaScript library so they can be invoked in the RAVE JavaScript library to render the widget. The visualization 460 illustrated in FIG. 4 may be the rendered widget, which may be viewable on the web browser that initially entered the URL in step S501.

The workflow of FIG. 5 further includes the Frontend 430 determining whether there is any unprocessed visualization left within the identified visualization (S512). For example, the identified visualization may include several objects (e.g., graph1, graph2, table1, table2, etc) to visualize. If there is an unprocessed visualization left, then the View Logic 431 re-executes step S506 to contact the Backend 430 to retrieve the specification of the unprocessed visualization, and the method continues as before to step S507.

If there is no unprocessed visualization to process, the View Logic 431 waits for a triggering event (S513). Examples of a triggering event include a user generated event such as a user entering a new URL or clicking on a new URL, or another event such as a timer.

If the triggering event occurs, the Frontend 430 determines whether the event involves an update of one of the processed visualizations (i.e., rendered widgets) (S514). If the event does involve one of the visualizations to update, the method proceeds to step S506 to retrieve the specification for updating the visualization. For example, the event could be a timer associated with a rendered graph that when the timer reaches a particular time, signifies the points of the graph are to be updated. If the event does not involve update of an existing visualization, the Frontend 430 handles the event internally (S515).

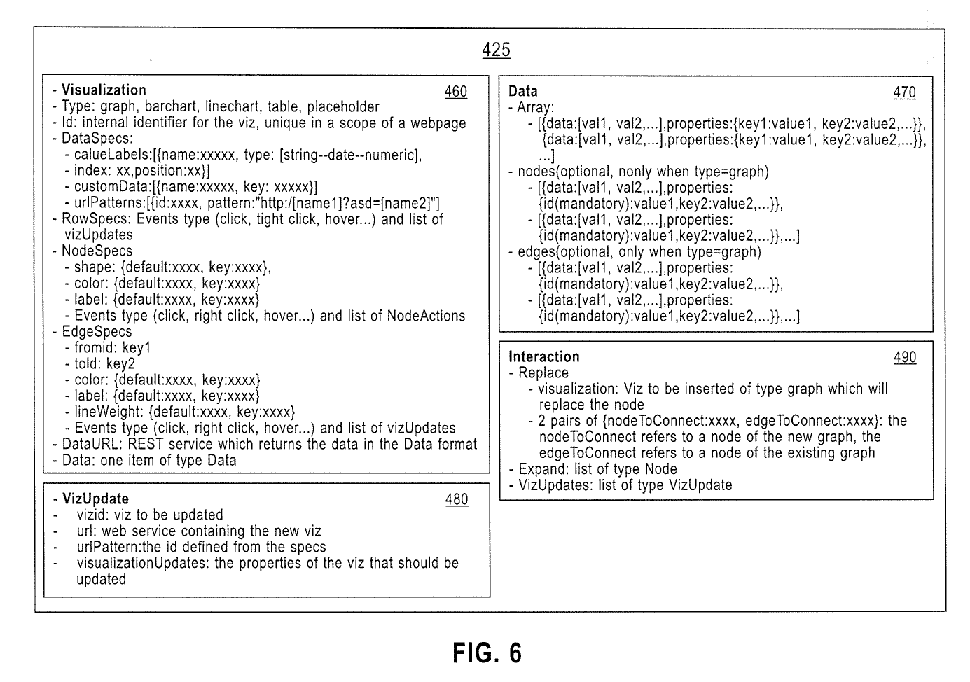

For example, if the visualization to render identified in step S505 is that of a graph, the View Logic 431 makes a request to the Backend 410 to retrieve the specification of the graph, the Routes Manager 415 maps the request to a REST method of the REST Controller 413, and the REST Controller 413 uses the REST method to access the Database Model adaptor 412 to retrieve the graph data for the graph (e.g., points, axis labels, information on which points on connected to which points, line style, color, etc.). The Controller Adaptor 414 converts the graph data into the data message 425 having the above described proprietary format so it can be forwarded to a selected one of the visualization adaptors 451-45N by the View Logic 431. As an example, the proprietary format may include certain fields in a certain order in a JavaScript Object Notation (JSON) or an Extensible Markup Language (XML) format. In an embodiment, the proprietary format of the data message 425 includes visualization information 460, data 470, visualization update information 480, and interaction information 490 organized as shown in FIG. 6.

The visualization information 460 includes information on how to visualize (e.g., illustrated) the data. The visualization information includes the type of the visualization (e.g., graph, bar chart, line chart, table, or placeholder). The placeholder may be a wrapper HTML element (e.g., div) that will contain in the future some visualization. The data message 425 may contain the specifications for all the placeholders, namely the location of a given visualization in the page, the association with the visualization, and information on how to populate or render the visualization.

The visualization information may include an identifier (e.g., see Id in Visualization 460), which is an internal identifier used for the visualization, which is unique in the scope of a webpage. For example, the identifier may be used to create an association with a placeholder, or to specify a relationship with another visualization or some in property that that is common to several visualizations (e.g., “if user clicks on visualization with id=3 then update the visualization with id=5 accordingly).

The visualization information 460 may include data specifications, which include the names or values of labels that are to be visualized, custom data, or an URL pattern. For example, the visualization information 460 may include a position to express a particular order for a visualization or the position of some subset of the data in a particular graph or chart. The URL pattern may be URL with an ID for easy reference, but might include some wildcards to specify complex behavior.

The visualization information 460 may include information on a type of event (e.g., click, right click, hover, etc.). The visualization information may include style information (e.g., the shape of each point, the color of each point, the label of a given point, and an action that occurs when a certain event (e.g., click, right click, hover, etc) occurs over a given point) about how the points of graph are to be visualized when the type of visualization is a graph. When the type of the visualization is a graph, the visualization may include style information about the edges that connect the points together (e.g., identifiers of points a given edge is to be drawn connecting, color of the edge, label for the edge, line style or thickness of the edge, and an action that occurs when a certain event (e.g., click, right click, hover) occurs over a given edge).

The visualization information 460 may include an URL that is mapped by the Routes Manager 415 to an action/method of the REST controller 413, which returns data that is provided in the data information 470.

The visualization update information 480 is optional and includes an identifier (e.g., see vizId) of the visualization that is to be updated. For example, if a given webpage has three graphs, and the visualization to be updated is the 2^{nd} graph, its visualization identifier could be VizId2. The visualization update information may include an URL or URL pattern, which is the location of a web service containing the new/updated visualization. The visualization update information may include the properties of the visualization that should be updated.

The Data 470 of the message 425 may include array data when the visualization type is a table, where the data of the array is used to populate the table, and node or point data and edge data when the visualization type is a graph. The node/point data includes an identifier for each node/point and a value (e.g., x, y data) and the edge data includes an identifier for each edge and the identifiers of the points the edge is connected to.

The Interaction information 490 is optional and includes information that can be used to replace a part of an object (e.g., a graph) or expand on a part of the object. The visualization information 460 may include the visualization type (e.g., graph, bar chart, etc.) that is to be inserted that can be used to replace one or more nodes/points, edges, etc. The visualization information 460 may include information on the new nodes of the graph and the existing nodes of the graph that is to be replaced/updated with the new nodes or the edges of the existing graph that the new nodes are to be connected to. The Interaction information 490 may include information that indicates how often to redraw a given visualization (e.g., redraw graph every 10 seconds or add information every 3 seconds). The Interaction information 490 may include information used to render a sub-visualization of a visualization or zoom into a visualization to display additional data such as the label of nodes.

In an exemplary embodiment, the View Logic 431 provides a user interface to a developer that enables the user to select one of the available visualization library adaptors 451. 452, . . . , 45N. In an exemplary embodiment, the selected visualization adaptor 451 is pre-selected from a value pre-defined in a file.

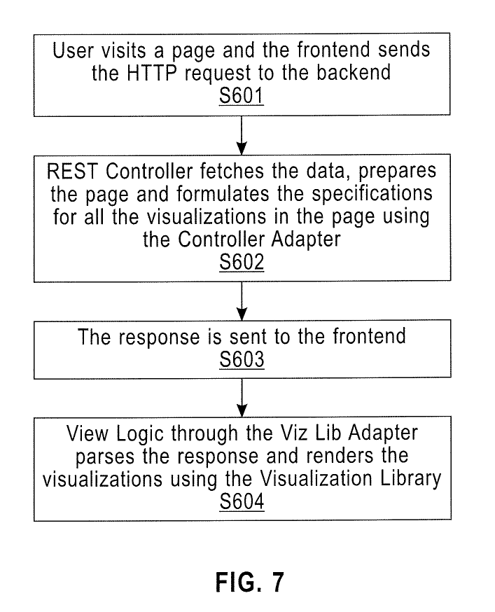

FIG. 7 illustrates a method of using the system of FIG. 4 according to an exemplary embodiment of the invention. In this method, all the information is exchanged with one single HTTP request, and the response from the Backend 410 contains the page and all the specifications of the visualizations. Referring to FIG. 7, the method includes a user visiting a webpage and the Frontend 430 sending an HTTP request to the Backend 410 for data of the webpage (S601). The REST Controller 413 fetches the data, prepares the page and formulates the specifications in a response for all the visualizations in the page using the Controller Adaptor 414 (S602). The REST Controller 413 then sends the response (e.g., data message 425) to the Frontend 430 (S603). The View Logic 431 of the Frontend 430 through one of the Visualization Library Adaptors 451-45N parses the response and renders the visualizations using a corresponding one of the Visualization Libraries 441-44N (S604).

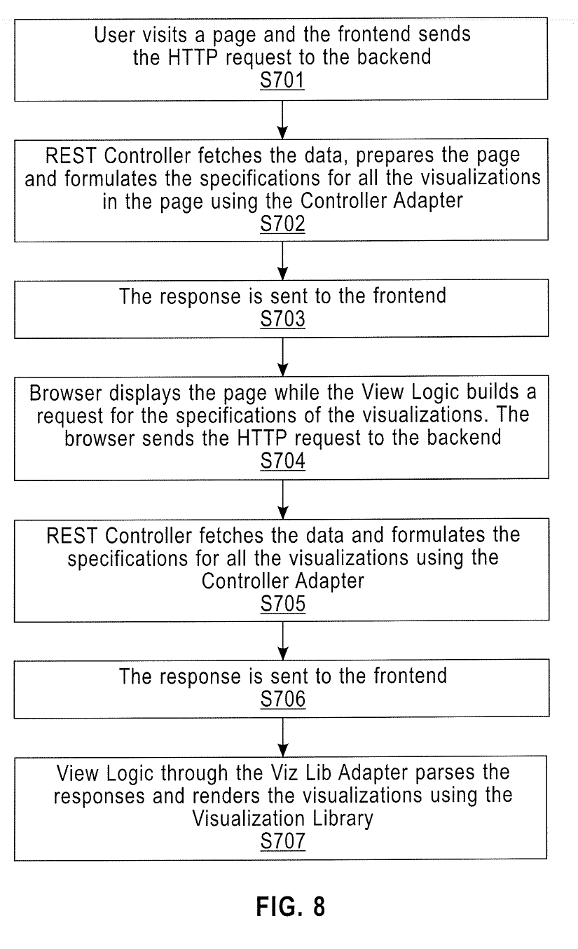

FIG. 8 illustrates a method of using the system of FIG. 4 according to an exemplary embodiment of the invention. In this method, there are multiple requests. The first one is to get the webpage and the visualization structure, namely the Backend 410 is returning a set of placeholders plus the specification on how to populate the placeholders with the visualization. The task of the View Logic 431 (e.g., developed by a frontend engineer) is to iterate through all the placeholders and get the relative visualizations. This can be done for example by formulating a single AJAX request for a placeholder/visualization and the Backend 410 in this case will respond with the specification of every single visualization. Referring to FIG. 8, the method includes a user visiting a webpage using a browser and the Frontend 430 sending an HTTP request to the Backend 410 for data of the webpage (S701). The REST controller 430 fetches the data, prepares the webpage and formulates the specifications into a response for all the visualizations in the page using the Controller Adaptor 414 (S702). For example, the response has the format of the data message 425. The Backend 410 sends the response to the Frontend 430 (S703). The browser displays a page based on the response while the View Logic 431 builds an HTTP request for the specifications of the visualizations, and the browser sends the HTTP request to the Backend 410 (S704). The REST controller 413 fetches data for the request and formulates specifications into a response (e.g., in the format of the data message 425) for all visualizations of the fetched data using the Controller Adaptor 414 (S705). The Backend 410 sends the response (e.g., in the format of the data message 425) to the Frontend 430 (S706). The View Logic 431, using the Visualization Library Adaptor (e.g., 451), parses the response and renders the visualizations using the corresponding Visualization Library (e.g., 441) (S707).

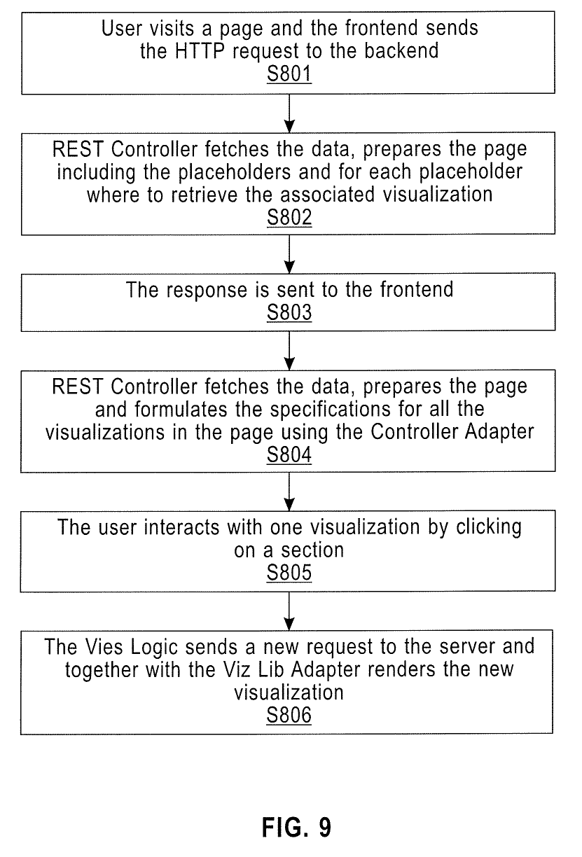

FIG. 9 illustrates a method of using the system of FIG. 4 according to an exemplary embodiment of the invention. In this method, there are multiple requests. The first one is for asking for the webpage including all the specifications of the visualizations in that page. The specification includes also some kind of user interaction (e.g., “if user clicks in some area, then visualize new chart”). The interaction generates a new request to the Backend 410, and the REST Controller 413 and Controller Adaptor 414 will take care of this new request and the response sent to the Frontend 430 will be parsed by a Visualization Library Adaptor (e.g., 451). Referring to FIG. 9, the method includes a user visiting webpage and the Frontend 430 sending an HTTP request for data of the webpage to the Backend 410 (S801). The REST controller 413 fetches placeholder data, prepares a response for a page including the placeholders and for each placeholder where to retrieve the associated visualization (S802). The Backend 410 sends the response to the Frontend 430 (S803). The REST controller 413 fetches data that the placeholders are to be filled with, prepares the page and formulates specifications for all visualizations in the placeholders of the page using the Controller Adaptor 414 (S804). The user then interacts with one visualization on the page by clicking on a section (S805). The View Logic 431 sends a new request to the Backend 410 for update data to update this section, and together with a Visualization Adaptor (e.g., 451), the section is updated or rendered with a new visualization (S806).

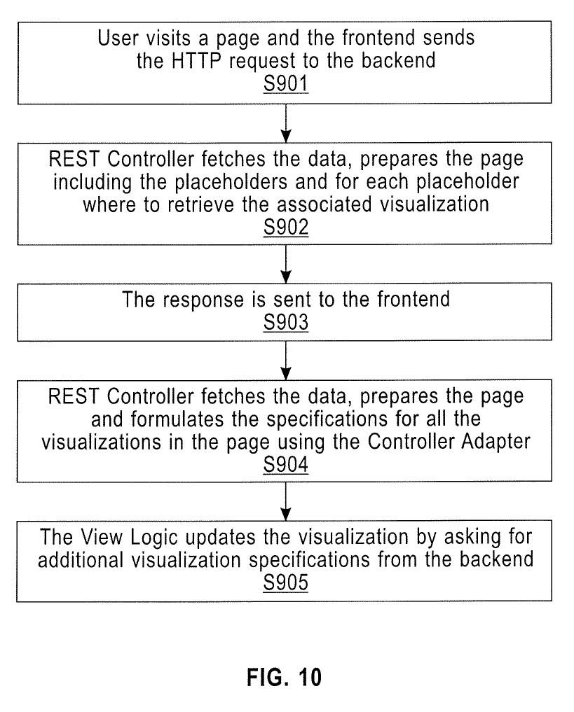

FIG. 10 illustrates a method of using the system of FIG. 4 according to an exemplary embodiment of the invention. In this method, there are multiple requests. The first one is for asking for a webpage and all the specifications of the visualizations included in that page. The specification includes also some update for the visualization (e.g., update certain data every X seconds). The update will be managed by the View Logic 431 and multiple requests will be sent to the Backend 410 in order to get the specification for the visualization updates. As an example, these updates can be done by reloading the page or using an asynchronous call such as AJAX. Referring to FIG. 10, the method includes a user visiting a page and the Frontend 430 sending an HTTP request for data of the page to the Backend 410 (S901). The REST controller 413 fetches placeholder data for a response, prepares a response for a page including the placeholders and for each placeholder where to retrieve the associated visualization (S902). The Backend 410 sends the response to the Frontend 430 (S903). The REST controller 413 fetches data to fill the placeholders, prepares the page and formulates specifications for all visualizations in the placeholders of the page using the Controller Adaptor 414 (S904). The View Logic 431 updates the visualization by asking the Backend 410 for additional visualization specifications (S905).

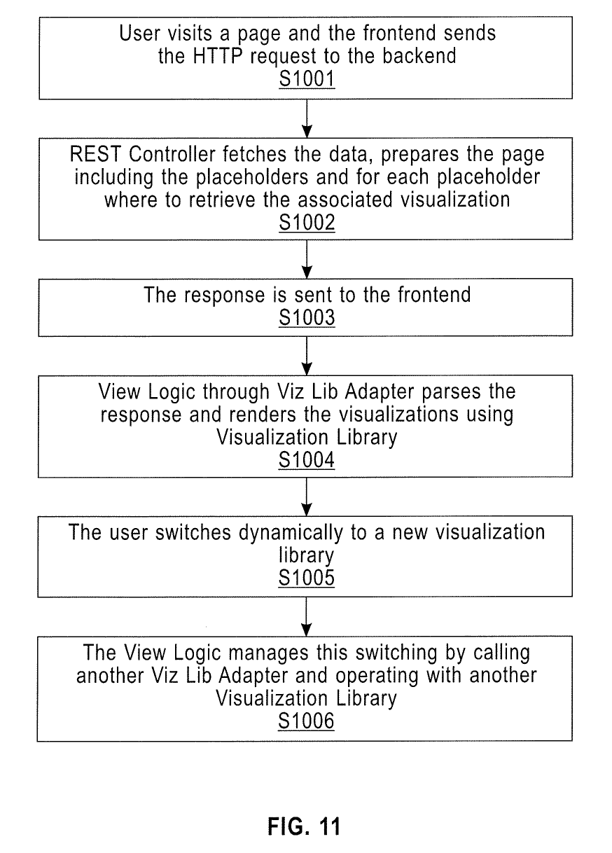

FIG. 11 illustrates a method of using the system of FIG. 4 according to an exemplary embodiment of the invention. In this method, the system allows a user to switch dynamically (e.g., at runtime) between the visualization libraries. The frontend developer implements this capability inside of the View Logic 431, which is responsible for orchestrating the switching between the different visualization libraries 441-44N. When the user desires to change a visualization library, the View Logic 431 can make additional requests to the Backend 410. For example, the View Logic 431 can make additional requests to implement some visualization library specific behavior. The REST controller 413 though the Controller Adaptor 414 is responsible for taking care of the new requests. Referring to FIG. 11, the method includes a user visiting a web page and the Frontend 430 sending an HTTP request to the Backend 410 to request data for the webpage (S1001). The REST controller 413 fetches the placeholder data, prepares a response for the page including the placeholders and for each placeholder where to retrieve the associated visualization (S1002). The Backend 410 sends the response to the Frontend 430 (S1003). The View Logic 431, using a selected first Visualization Library Adaptor (e.g., 451), parses the response and renders the visualizations using a corresponding first Visualization Library of the first Visualization Library Adaptor (S1004). A user then switches dynamically to a second other visualization library (S1005). For example, the user may use a user interface provided by the View Logic 431 to select the second visualization library. The View Logic 413 manages this switching by calling the second Visualization Library Adaptor (e.g., 452) and operating on its corresponding Visualization Library (e.g., 442). For example, the View Logic, through the second Visualization Library Adaptor, re-parses the response and renders the visualizations using the second Visualization library. A copy of the response sent to the Frontend during step S1001 may have been retained by Frontend 430 so it can be parsed by the second Visualization Library Adaptor in step 1006 to create the visualizations based on the second Visualization Library.

The interaction between a client of the web browser and a server housing the Backend 410 according to an embodiment of the invention is defined by a certain set of rules. The client specifies the desired visualization library (e.g., D3, jQuery, etc.). The client then retrieves the initial set of widget specifications (e.g., the visualization for a graph, a chart, a table, etc.) from a pre-agreed entry point (e.g., /viz/ROOT/). The View Logic 431 iterates over a response and populates a user interface with: 1) visualization objects, each consisting of a type (e.g., the type of visualization such as graph, chart, table, etc.), data (e.g., either, actual data or references to data, and actions that are rendered using the specified library; 2) link objects, each consisting of behavior associated with interactive entities (e.g., such as buttons, html links, etc.); 3) and placeholder objects, that can be rendered by interacting with the visualizations. The library may be specified by the developer of the Frontend 430 during development or at runtime if the developer allows for the capability of dynamically switching between libraries.

In an exemplary embodiment, the Controller Adaptor 413 provides within the data message 425, the type of visualization, the data to be visualized, the interaction information, and the routes. The interaction information may be omitted. The routes specify the mapping between an URL and a method or an action of the REST controller 413. The Controller Adaptor 414 may also include procedures on how to update a given visualization, a page composition, the library to render, or library specific settings.

Please note that while FIG. 4 illustrates each Visualization Library Adaptor 451-45N being incorporated into a respective one of the Visualization Libraries 441-44N, in an alternate embodiment, the Visualization Library Adaptors 451-45N are not incorporated with a respective Visualization Library. In this embodiment, a Visualization Library Adaptor (e.g., 451) is a separate application from that of its corresponding Visualization Library (e.g., 441). In this embodiment, the Visualization Library Adaptor (e.g., 451) may have knowledge of the location (e.g., directory and filename) of the corresponding Visualization Library (441), and use this knowledge to call the Library to render widgets as necessary. In another exemplary embodiment, the separate application representing a Visualization library adaptor is located either on the Frontend 410 or the Backend 430. When the separate application is located on the Backend 410, it may be used to pre-render a widget and send the pre-rendered widget to the Frontend 430 for visualization.

The modules shown in the above figures may be implemented by various manners, including software, hardware, firmware or a random combination thereof. For example, in some embodiments, the apparatus may be implemented by software and/or firmware. Alternatively or additionally, the system of FIG. 4 may be implemented partially or completely based on hardware. For example, one or more units in the system may be implemented as an integrated circuit (IC) chip, an application-specific integrated circuit (ASIC), a system on chip (SOC), a field programmable gate array (FPGA), etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of web-based data visualization, the method comprising:
sending, by a client configured as a Frontend, a request over a computer network to a server configured as a Backend;
fetching, by a web server of the server, data responsive to the request;
sending, by the web server, a response to the Frontend in a format compatible with a plurality software adaptors located on the Frontend, the response including information about objects to be presented on a web component;
passing, by logic of the Frontend, the response to a selected one of the software adaptors; and
rendering, by the selected software adaptor, the web component using a web visualization library associated with selected software adaptor.

2. The method of claim 1, wherein the format that is compatible with the plurality of software adaptors is not compatible with the web visualization library.

3. The method of claim 1, wherein the rendering comprises:
converting, by the selected software adaptor, the response into a first message that is compatible with a first web visualization library associated with the selected software adaptor; and
rendering, by the selected software adaptor, the web component using the first message and the first web visualization library.

4. The method of claim 1, further comprising:
upon determining, by the logic, that an event has occurred on the Frontend requiring update of part of the web component, the logic sending a second request to the Backend for updated data;
converting, by the selected software adaptor, a second response received from the Backend in response to the second request into a first message that is compatible with the web visualization library; and
updating, by the selected software adaptor, the web component using the first message and the web visualization library.

5. The method of claim 1, further comprising:
upon determining, by the logic, that the response indicates that a part of the web component needs to be updated, the logic sending a second request to the Backend for updated data;
converting, by the selected software adaptor, a second response received from the Backend in response to the second request into a first message that is compatible with the web visualization library; and
updating, by the selected software adaptor, the part of the web component using the first message and the web visualization library.

6. The method of claim 1, wherein the Frontend includes a plurality of different web visualization libraries, and each software adaptor is located in a respective one of the web visualization libraries.

7. The method of claim 6, wherein the web visualizations libraries are JavaScript libraries.

8. The method of claim 3, further comprising:
determining, by the logic, that a user has switched from the first web visualization library to a second web visualization library;
passing, by the logic, the response to a second one of the software adaptors associated with the second web visualization library;
converting, by the second software adaptor, the response into a second message that is compatible with the second web visualization library; and
rendering, by the second software adaptor the web component using the second message and the second web visualization library.

9. A method of web-based data visualization, the method comprising:
sending, by a client configured as a Frontend, a request for data of a web component over a computer network to a server configured as a Backend;
passing, by logic of the Frontend, a first message received in response to the request to a selected one of a plurality software adaptors, wherein the first message is a format compatible with the software adaptors, and the first message includes information about objects to be presented on the web component; and
rendering, by the selected software adaptor, the web component using a web visualization library associated with selected software adaptor.

10. The method of claim 9, wherein the first message is sent by a Representational State Transfer (REST) capable web server of the Backend and the request is a Hyper Transfer Protocol request.

11. The method of claim 9, wherein the format that is compatible with the plurality of software adaptors is not compatible with the web visualization library.

12. The method of claim 9, wherein the rendering comprises:
converting, by the selected software adaptor, the first message into a second message that is compatible with a first web visualization library associated with the selected software adaptor; and
rendering, by the selected software adaptor, the web component using the second message and the first web visualization library.

13. The method of claim 9, further comprising:
upon determining, by the logic, that an event has occurred on the Frontend requiring update of part of the web component, the logic sending a second request to the Backend for updated data;
converting, by the selected software adaptor, a second message received from the Backend in response to the second request into a third message that is compatible with the web visualization library; and
updating, by the selected software adaptor, the web component using the third message and the web visualization library.

14. The method of claim 9, further comprising:
upon determining, by the logic, that the response indicates that a part of the web component needs to be updated, the logic sending a second request to the Backend for updated data;
converting, by the selected software adaptor, a second message received from the Backend in response to the second request into a third message that is compatible with the web visualization library; and
updating, by the selected software adaptor, the part of the web component using the third message and the web visualization library.

15. The method of claim 9, wherein the Frontend includes a plurality of different web visualization libraries, and each software adaptor is located in a respective one of the web visualization libraries.

16. The method of claim 14, wherein the web visualizations libraries are JavaScript libraries.

17. The method of claim 12, further comprising:
determining, by the logic, that a user has switched from the first web visualization library to a second web visualization library;
passing, by the logic, the response to a second one of the software adaptors associated with the second web visualization library;
converting, by the second software adaptor, the response into a third message that is compatible with the second web visualization library; and
rendering, by the second software adaptor the web component using the third message and the second web visualization library.

18. A method of web-based data visualization, the method comprising:
mapping, by logic of a server configured as a Backend, a request to a method of a web server of the Backend;
fetching, by the web server, data responsive to the request in response to the mapping; and
sending, by the web server, a response to a client configured as a Frontend that sent the request in a format compatible with a plurality software adaptors located on the Frontend, the response including information about objects to be presented on the web component,
wherein the format that is compatible with the plurality of software adaptors is not compatible with web visualization libraries associated with the software adaptors.

19. The method of claim 18, wherein the request is received from the Frontend over computer network in response to a user entering a web address into a browser.

20. The method of claim 18, wherein the web server is a Representational State Transfer (REST) capable web server and the request is a Hyper Transfer Protocol request.
